(19) United States
(12) Patent Application Publication
(10) Pub. No.: US 2026/0270193 A1
(43) Pub. Date: Sep. 10, 2026

(54) MULTIPLE VPN TUNNELS AND URSP TRAFFIC CATEGORIES

(71) Applicant: Telefonaktiebolaget LM Ericsson (publ), Stocklom (SE)

(72) Inventors: Jari Vikberg, Järna (SE); Jan Backman, Kärna (SE)

(21) Appl. No.: 19/162,940

(22) PCT Filed: Mar. 6, 2023
(86) PCT No.: PCT/SE2023/050196

§ 371 Date: Sep. 7, 2025

(51) Int. Cl. H04L 45/302; H04L 12/46

(52) U.S. Cl. CPC H04L 45/302; H04L 12/4633; H04L 12/4641

(57) ABSTRACT

Multiple Virtual Private Network (VPN) solution, wherein each VPN can be associated with a specific Quality of Service (QoS) level in the Communication Service Provider (CSP) network which is achieved by a 2 step User Equipment Route Selection Policy (URSP) traffic category mapping where first, application flows are mapped to the VPNs based on a URSP traffic category, and then second, each VPN is mapped to the CSP Protocol Data Unit (PDU) Sessions based on the URSP traffic category. Application flows can thus be prioritized or handled based on the determined QoS level, but the application flows can be encrypted between the UE and an application server.

### TECHNICAL FIELD

The present disclosure relates to multiple Virtual Private Network (VPN) tunnels and User Equipment Route Selection Policy (URSP) traffic categories being applied to the VPN tunnels in a wireless communications system.

### BACKGROUND

### 5G Background

Standardization work has been ongoing in Next Generation Radio Access Network (NG-RAN) and Fifth Generation (5G) Core network (5GC) as new radio access and new packet core network since Third Generation Partnership Project (3GPP) Rel-15 (see 3GPP Technical Specification (TS) 23.501 and 23.502 for stage-2 descriptions). FIG. 1 shows a 5G System architecture using service-based representation (corresponds to FIG. 4.2.3-1 from TS 23.501 V18.0.0).

FIG. 2 shows the internal architecture for a gNB 202 i.e., referring to a base station supporting New Radio (NR) Radio Access Technology (RAT) in the RAN of FIG. 1 and is referred to as a NG-RAN in this case (see 3GPP TS 38.401 for stage-2 description of NG-RAN). FIG. 2 assumes that both Higher Layer Split (HLS) and Control Plane 204 and User Plane 206 split (CP-UP split) have been adopted within the gNB 202.

### QoS Principle in 5GS

Quality of Service (QoS) is managed in a 5G wireless network, i.e., in a 5G System (5GS) on a per QoS flow level from the Core Network (CN). The NG-RAN (i.e., gNB or ng-eNB) is responsible for setting up the radio bearers for QoS Flows, radio resource management, and enforcing QoS according to the QoS Flow Profile—over the radio interface in the downlink and over the transport network in the uplink. QoS Flows are identified by a QoS Flow ID (QFI). QoS Flows including a QoS Profile are set up between the User Plane Function (UPF) in the 5GC and the user equipment device (UE).

5GS has defined a new term called a PDU session that is very similar to a PDN connection in the earlier mobile generations. One difference is that there is normally only a single N3/NG-U tunnel (a GTP-U tunnel) for each PDU session between the UPF and NG-RAN. This means that the mapping of different traffic/QoS flows to radio bearers is performed in the NG-RAN, for example a radio bearer can carry one or more QoS Flows. A QoS Flow is the finest granularity of QoS differentiation in a Protocol Data Unit (PDU) session. Each QoS Flow is associated with QoS parameters that are used to enforce the correct traffic forwarding treatment. Each packet belongs to a QoS Flow and one PDU session can carry one or several QoS Flows.

The QoS Flow level QoS Parameters can be either non-dynamic or dynamic. The Non-dynamic case is very similar to the QoS Class Identifier (QCI) concept in Evolved Packet System (EPS) but is called as 5G QoS Identifier (5QI). The 5QI is a scalar that is a part of the 5G QoS parameters and it is used as a reference to standardized (i.e., pre-configured) 5G QoS characteristics that control QoS forwarding treatment for the QoS Flow (e.g., scheduling weights, admission thresholds, queue management thresholds, link layer protocol configuration, etc.), see TS 23.501 clause 5.7.2 and particularly clause 5.7.2.1. This means that the 5QI value as such is signaled from 5GC to NG-RAN and defines the main characteristics for the QoS Flow. The dynamic case is somewhat different as in this case actual 5G QoS characteristics are also signaled from 5GC to NG-RAN. These signaled characteristics may include Priority Level, Packet Delay Budget, Packet Error Rate, Delay Critical, Averaging Window and Maximum Data Burst Volume, see TS 23.501 clause 5.7.2.1 and particularly clause 5.7.3.

### Traffic Classification

Traffic classification is about how to map different applications and their corresponding application flows from a specific UE to different network resources (e.g., network slices, PDU sessions, QoS flows and Radio Bearers) in both uplink (UL) and downlink (DL). Such network resources may have separate 5G QoS parameters and characteristics associated to them. Network Initiated-Quality of Service (NI-QoS) and URSP are examples of traffic classification mechanisms with different control points. Traffic classification is an essential functionality for any QoS support in mobile networks. It is however important to understand that additional functionality is needed when networks are planned and deployed with QoS support in mind. Examples of additional functionality needed are Service Level Agreement (SLA) and SLA assurance support. Most applications use multiple application flows with different requirements. This put demands on a mechanism to map individual application flows to the different network resources. In many cases, mapping at application-level will not be enough. An example of traffic classification, such as URSP, is depicted in FIG. 3, where a UE 302 communicates with an application provider 306 via a communication service provider (CSP) 304. The UE 302 may have one or more applications 308 that have different QoS flows 310-1, 310-2, 310-3 that have respective QoS levels.

### Virtual Private Network (VPN) Solutions

A VPN extends a private network across a public network and enables users to send and receive data across shared or public networks as if their computing devices were directly connected to the private network. The benefits of a VPN include increases in functionality, security, and management of the private network. It provides access to resources that are inaccessible on the public network and is typically used for remote workers. Encryption is common, although not an inherent part of a VPN connection. A VPN is created by establishing a virtual point-to-point connection through the use of dedicated circuits or with tunneling protocols over existing networks. A VPN available from the public Internet can provide some of the benefits of a wide area network (WAN). From a user perspective, the resources available within the private network can be accessed remotely.

### Exemplary VPN Solution

FIG. 4 is a depiction of an exemplary VPN solution that includes a private relay. A VPN solution with a private relay can allow users to connect to and browse the web in a more secure and private way. When browsing with a web browser, a private relay solution ensures all traffic leaving a user's device 402 from an application 404 is encrypted, so no one between the user and the website they are visiting can access and read it, not even the user's network provider. All the user's requests are then sent through two separate internet relays (ingress proxy 412 and egress proxy 414). The ingress proxy 412 assigns the user an anonymous Internet Protocol (IP) address that maps to their region but not their actual location. The egress proxy 414 decrypts the web address they want to visit and forwards them to their destination. This separation of information protects the user's privacy because no single entity can identify both who a user is and which sites they visit.

FIG. 4 shows some of the details a private relay solution, for example how the encrypted ingress tunnel 420 is between an operating system 406 of the UE 402 and the Ingress Proxy 412. The Ingress Proxy 412 will allocate a new IP address for the UE 402 and thereby hide the real UE IP address both from the Egress Proxy and from the Application Servers. The encrypted Egress tunnel 418 is between the UE 402 and the Egress Proxy 414. The Egress proxy 414 decrypts the destination Application Server (or web server) name and address. This mean that the Ingress Proxy 412 is not aware of the destination of the UE traffic. Finally, an application flow is shown between an App Client-X 404 on the UE 402 and an App Server-X 416. In the application flow, App Server-X 416 communicates unencrypted with Egress Proxy 414 that in turn uses the encrypted tunnel 418 to further communicate with the UE 402 via the Ingress Proxy 412. This means that the Ingress Proxy 412 is not aware of the App Server-X 416 name and address, since that is encrypted by the Egress Proxy 414.

### Solutions for URSP Traffic Categories

Traffic categories are needed to communicate QoS needs in a simple and generic way such as low latency and different levels of bandwidth requirements. Traffic categorization is therefore a variant of the traffic classification discussed above, i.e., all applications and application flows indicating the same traffic category would be classified to the same network resources.

URSP is standardized by 3GPP for a UE connected to multiple slices and/or PDU Sessions. The 3GPP standards define multiple different types of traffic descriptors such as DNN, domain, IP and application descriptors that would in principle allow both application and application flow level mapping to network resources (see 3GPP TS 23.503 chapter 6.6.2). Some device Operating System (OS) vendors have taken their own initiative on interpreting the App-ID field (i.e., the “Application descriptors” in table 6.6.2.1-2 of 3GPP TS 23.503) in the URSP rules. Instead of identifying an application, as actually defined in 3GPP TS 23.503, they put in a traffic category that the application could specify when setting up the communication. These traffic categories were not controlled by the operator, instead the operator is supposed to define a matching subscription and map to this with the aid of the traffic categories. Examples of such traffic categories are “Low Latency” and “High Bandwidth”. 3GPP Rel-18 contains work to standardize the traffic categories as part of Connection Capabilities (as defined in table 6.6.2.1-2 of 3GPP TS 23.503). Amongst others, this activity contains the classes “On demand downlink streaming” (mapping well to “High Bandwidth”), “Real time interactive traffic” (mapping well to “Reliability”) and “Critical communications” (that maps well to “Low Latency”). The following steps are illustrated in FIG. 5:
1. URSP rules are sent to the UE 502 (i.e., UE modem 504) from the Policy Control Function (PCF) 514 in the core network 516.
   a) As an example the URSP rules contain the following 3 rules:
      Default/Best Effort: when no other rules match, pointing to the DNN Selection field in the Route Selection component with the value: “Internet PDU Session, best effort”
      Low Latency: URSP Traffic Category “LOW LATENCY”, pointing to the DNN Selection field in the Route Selection component with the value: “Internet PDU Session, low latency”
      Background: URSP Traffic Category “BACKGROUND”, pointing to the DNN Selection field in the Route Selection component with the value: “Internet PDU Session, background”
2. URSP rules are read into the URSP rule cache 506 in the Operating System (OS) 510 of the UE 502.
3. App Client-X 508 is requesting a socket and indicates also a specific Traffic Category.
   a) As an example, the indicated Traffic Category is “LOW LATENCY”.
4. OS 510 parses the URSP rules in the URSP rule cache 506.
5. OS 510 requests the modem to create the relevant PDU session for the requested Traffic Category based on the parsed URSP rules (if needed i.e., when that PDU Session is not already established).
   a) Note that in FIG. 5, 3 different PDU sessions (512) are already shown as established.
   b) As an example, the relevant PDU session is “Internet PDU Session, low latency” 512-2.
6. The socket requested by App Client-X 508 is bound to the source IP for the PDU Session associated with the requested Traffic Category and the socket is ready for use.

Both private relay, and other single-VPN solutions, and URSP Traffic Categories have their merits in ensuring end user privacy and enabling different levels of Quality of Experience (QoE) or QoS for different application flows. The main problem to be solved is that traditionally with VPN solutions, it is not possible to apply traffic classification to the VPN tunnels, as the tunnels are encrypted and the CSP is not able to distinguish traffic associated with the VPN tunnels.

### SUMMARY

The present disclosure provides for multiple Virtual Private Network (VPN) solution, wherein each VPN can be associated with a specific Quality of Service (QoS) level in the Communication Service Provider (CSP) network which is achieved by a 2 step User Equipment Route Selection Policy (URSP) traffic category mapping where first, application flows are mapped to the VPNs based on a URSP traffic category, and then second, each VPN is mapped to the CSP Protocol Data Unit (PDU) Sessions based on the URSP traffic category. Application flows can thus be prioritized or handled based on the determined QoS level, but the application flows can be encrypted between the UE and an application server.

In an embodiment, the present disclosure includes a method performed by a User Equipment (UE) for enabling use of one or more VPN tunnels with URSP traffic classification. The method can include mapping each VPN tunnel to a respective PDU session of one or more PDU sessions, wherein each PDU session is associated with a respective URSP traffic category corresponding to a respective QoS level. The method can also include receiving a network connection setup request from a client application of the UE, where the network connection setup request indicates a URSP traffic category. The method can also include identifying a PDU session that is associated with a URSP traffic category based on the URSP traffic category indicated in the network connection setup request such that a network connection associated with the network connection setup request is bound to the identified PDU session. The method can also include transmitting data from the client application via the network connection to a VPN tunnel mapped to the identified PDU session, wherein the VPN tunnel is established over the identified PDU session.

In an embodiment, a UE can be configured for enabling use of one or more VPN tunnels with URSP traffic classification. The UE can include a radio interface and processing circuitry configured to map each VPN tunnel to a respective PDU session of one or more PDU sessions, wherein each PDU session is associated with a respective URSP traffic category corresponding to a respective QoS level. The processing circuitry can also be configured to receive a network connection setup request from a client application of the UE, where the network connection setup request indicates a URSP traffic category. The processing circuitry can also be configured to identify a PDU session that is associated with a URSP traffic category based on the URSP traffic category indicated in the network connection setup request such that a network connection associated with the network connection setup request is bound to the identified PDU session. The processing circuitry can also be configured to transmit data from the client application via the network connection to a VPN tunnel mapped to the identified PDU session, wherein the VPN tunnel is established over the identified PDU session.

In an embodiment, a non-transitory computer-readable medium comprising instructions stored thereon, that when implemented by a processor perform operations for enabling use of one or more VPN tunnels with URSP traffic classification. The operations can include mapping each VPN tunnel to a respective PDU session of one or more PDU sessions, wherein each PDU session is associated with a respective URSP traffic category corresponding to a respective QoS level. The operations can also include receiving a network connection setup request from a client application of the UE, where the network connection setup request indicates a URSP traffic category. The operations can also include identifying a PDU session that is associated with a URSP traffic category based on the URSP traffic category indicated in the network connection setup request such that a network connection associated with the network connection setup request is bound to the identified PDU session. The operations can also include transmitting data from the client application via the network connection to a VPN tunnel mapped to the identified PDU session, wherein the VPN tunnel is established over the identified PDU session.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates an example of a Fifth Generation (5G) system architecture;

FIG. 2 illustrates an example of a Next Generation Radio Access Network (NG-RAN) architecture;

FIG. 3 illustrates an example of traffic classification;

FIG. 4 illustrates an example of a private relay Virtual Private Network (VPN) solution;

FIG. 5 illustrates an example of User Equipment Route Selection Policy (URSP) traffic categorization;

FIG. 6 illustrates an example of multiple VPNs and URSP traffic categorization according to some embodiments of the present disclosure;

FIG. 7 illustrates a flow chart of a methodology for employing multiple VPNs and URSP traffic categorization according to some embodiments of the present disclosure;

FIG. 8 illustrates a message sequence chart for employing multiple VPNs and URSP traffic categorization according to some embodiments of the present disclosure;

FIG. 9 illustrates one example of a cellular communications system according to some embodiments of the present disclosure;

FIG. 10 is a schematic block diagram of a User Equipment device (UE) according to some embodiments of the present disclosure; and

FIG. 11 is a schematic block diagram of the UE of FIG. 10 according to some other embodiments of the present disclosure.

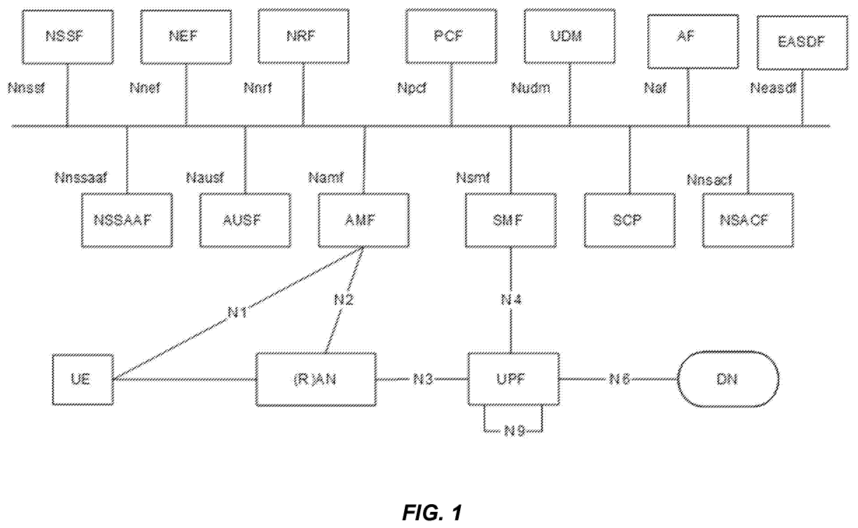

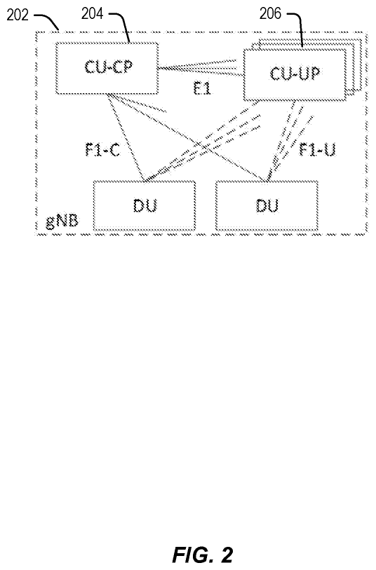

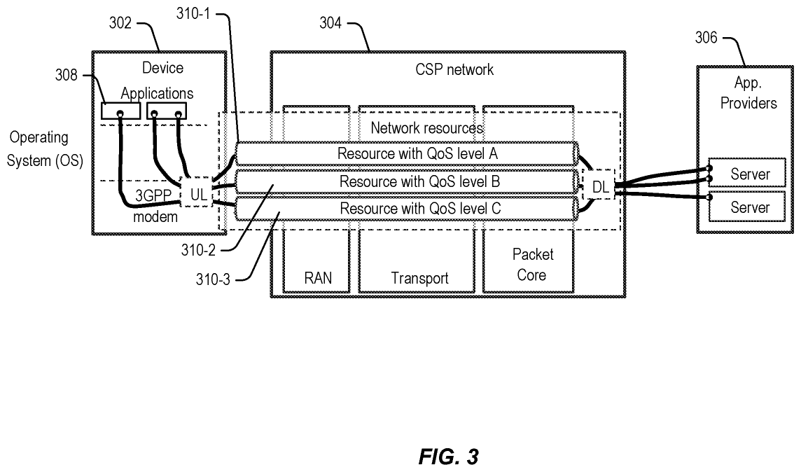

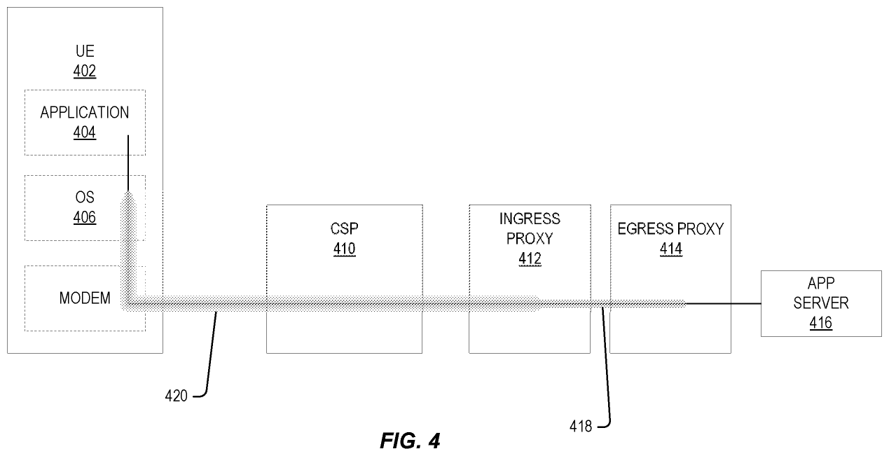

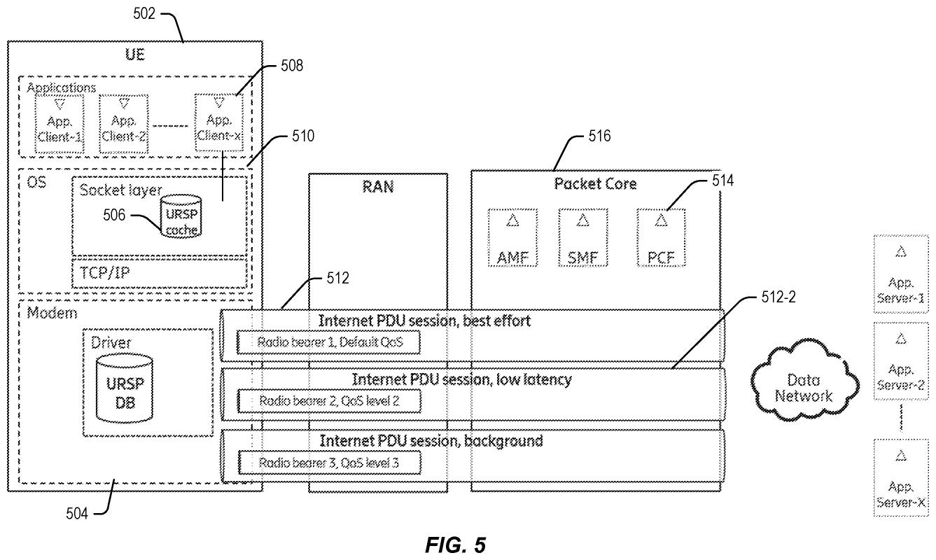

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

The present disclosure provides for multiple Virtual Private Network (VPN) solution, wherein each VPN can be associated with a specific Quality of Service (QoS) level in the Communication Service Provider (CSP) network which is achieved by a 2 step User Equipment Route Selection Policy (URSP) traffic category mapping where first, application flows are mapped to the VPNs based on a URSP traffic category, and then second, each VPN is mapped to the CSP Protocol Data Unit (PDU) Sessions based on the URSP traffic category. Application flows can thus be prioritized or handled based on the determined QoS level, but the application flows can be encrypted between the UE and an application server.

Some of the advantages provided by the techniques disclosed herein is the possibility to combine single-VPN solutions, and URSP Traffic Categories and therefore to get their combined merits as well i.e., ensuring end user privacy and enabling different levels of Quality of Experience (QoE) or QoS for different application flows. Another advantage is to further enhance privacy by using a private relay VPN solution with an ingress proxy and egress proxy while also taking advantage of URSP traffic categories to provide enhanced QoS for multiple application flows from one or more applications.

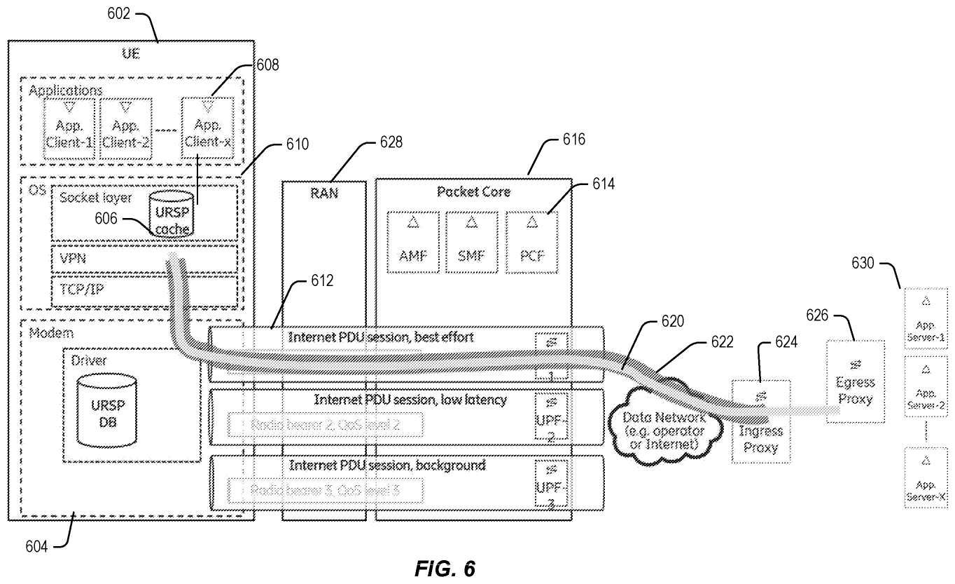

FIG. 6 illustrates an example of multiple VPNs and URSP traffic categorization according to some embodiments of the present disclosure.

USRP Rules are sent to the modem 604 of the UE 602 from the PCF 614 in the core network 616. As an example the URSP rules contain the following three rules: Default/Best Effort: when no other rules match, pointing to the DNN Selection field in the Route Selection component with the value: “Internet PDU Session, best effort”; Low Latency: URSP Traffic Category “LOW LATENCY”, pointing to the DNN Selection field in the Route Selection component with the value: “Internet PDU Session, low latency; and Background: URSP Traffic Category “BACKGROUND”, pointing to the DNN Selection field in the Route Selection component with the value: “Internet PDU Session, background”. In other embodiments, the URSP rules can include just the Low Latency and Background categorizations, and in other embodiments, there can be four or more traffic categorizations.

URSP rules are read into the URSP rule cache 606 of the operating system (OS) 610 of the UE 602. The present disclosure discloses novel techniques for how the PDU Sessions in the URSP rules are associated with tunnels/VPNs. In one example such association may be done already in this step, e.g., “Internet PDU Session low latency” is associated with “tunnel/VPN low latency”. In other embodiments, the association part of this step is done in the later steps.

As a further clarification of the example, all 3 PDU Sessions in the URSP rules may be associated with a tunnel/VPN already in this step:
“Internet PDU Session, best effort”←→“tunnel/VPN best effort”
“Internet PDU Session, low latency”←→“tunnel/VPN low latency”
“Internet PDU Session, background”←→“tunnel/VPN background”

App Client-X 608 can request requesting a socket and indicates also a specific Traffic Category. The indication of the Traffic Category may be implementation specific. In one example it could be a numeric socket option value associated with the request to create the socket. As an example, the indicated Traffic Category of the socket request is “Best Effort”.

The OS 610 can then parse the URSP rules in the URSP rule cache 606. As an example, the parsing of the URSP rules results in the following URSP rule.

Best Effort: URSP Traffic Category “Best Effort”, pointing to the DNN Selection field in the Route Selection component with the value: “Internet PDU Session, Best Effort”. The URSP rule may already be associated with a tunnel/VPN i.e., if this association was already performed in step 2. If the association was not done previously, then it is performed here:
“Internet PDU Session, best effort”←→“tunnel/VPN best effort”

OS 610 requests the modem 604 to create the relevant PDU session (e.g., 612) (for the requested Traffic Category (if needed i.e., when that PDU Session is not already established). The UE requested PDU Session establishment is defined in 3GPP TS 23.502 clause 4.3.2 and particularly clause 4.3.2.2.

As an example, the relevant PDU session is “Internet PDU session, best effort”. Note that in FIG. 6, three different PDU sessions, are already shown as being established.

Operating System (OS) 610 also establishes the tunnel/VPN 620/622 associated with the relevant PDU session (again if needed i.e., not already established). The tunnel/VPN 620/622 is established using the relevant PDU Session 612 as the network resource. The different tunnels/VPNs may be established either towards the ingress proxy 624 or the egress proxy 626. In an embodiment, there can be a single VPN tunnel established between the UE 602 and a single proxy (e.g., a Security Gateway). In addition, the address of the server 630 towards which the tunnels/VPNs 620/622 are established to can be retrieved by any means like DNS or local configuration in the UE 602.

As an example, the tunnel/VPN associated with the relevant PDU session is “tunnel/VPN best effort” and is established over the PDU Session “Internet PDU Session, best effort”.

Note that while using a traditional VPN system there can be 1 tunnel/VPN for “tunnel/VPN Best Effort”, but in FIG. 6, a private relay style VPN solution is provided where there are two VPN tunnels. A first tunnel is 622 is established from the UE 602 to an ingress proxy 624 via one or more RAN nodes of the RAN 628 and the core network 616. A second tunnel 620 can be established between the UE 602 to the egress proxy 626. The second tunnel 620 can be established within the first tunnel 622.

The socket requested by App Client-X 608 is bound to the source Internet Protocol (IP) address or prefix of the tunnel/VPN associated with the requested Traffic Category, that is also typically the source IP address or prefix of the PDU Session associated with the requested Traffic Category and is ready for use.

As an example, the created socket is bound to the “tunnel/VPN best effort” that is established over the PDU Session “Internet PDU Session, best effort”.

While FIG. 6 shows a single PDU session, there are two tunnels 622 and 620 that are established toward the ingress proxy 624 and the egress proxy 626 respectively in other embodiments, different application flows from the App Client X 608 or other applications can be associated with respective VPN tunnels over other PDU sessions.

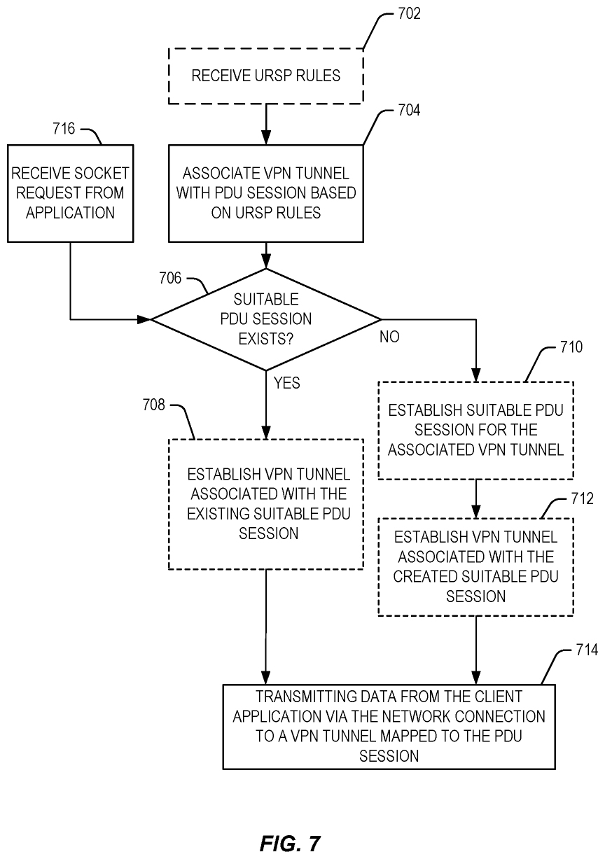

FIG. 7 illustrates a flow chart of a methodology for employing one or more VPNs and URSP traffic categorization according to some embodiments of the present disclosure. The method in FIG. 7 can be performed for example, by UE 602 from FIG. 6. Steps in the flowchart that have a dashed outline are optional, or not strictly required for the purposes of the disclosure.

At 702, the flowchart can begin when the UE 602 receives URSP rules from a core network node (616) (e.g., PCF 614). The URSP rules can define URSP traffic categories, including one or more of a low latency traffic category, a background traffic category, or a default (e.g., best effort) traffic category. Other traffic categories can include a high bandwidth traffic category, a medium bandwidth traffic category, a bounded medium latency traffic category, or a time-critical traffic category (very low latency). In an embodiment, a URSP rule of the URSP rules points to a Data Network Name, DNN selection field, in the Route Selection component that indicates a PDU session for a corresponding URSP traffic category.

At 704, the UE 602 can associate or map each VPN tunnel to a respective PDU session of one or more PDU sessions, wherein each PDU session is associated with a respective URSP traffic category corresponding to a respective QoS level. The mapping of each VPN tunnel of the one or more of VPNs tunnels to respective PDU sessions is based at least in part on the URSP rules. In one embodiment, the UE 602 can, based on the received URSP rules, identify all the different PDU sessions that are listed in the different URSP rules, and thus the number of different tunnels or VPNs that may be established. In an embodiment, or optionally, the mapping at 704 can be performed in response to or after a network connection setup request is received from an application step 716. The network connection setup request can be associated with one or more application flows from the client application. In an embodiment, the network connection setup request can be a socket request.

At step 706, the UE 602 can identify whether a PDU session that is associated with a URSP traffic category indicated in the network connection setup request is established already.

If there is no PDU session already established, at step 710, the UE 602 can create a suitable PDU session for the associated VPN tunnel, and then at step 712, create the VPN tunnel for the newly established PDU session.

At step 714, the UE 602 can transmit data from the client application (608) via the network connection to a VPN tunnel mapped to the identified PDU session, wherein the VPN tunnel is established over the identified PDU session.

If a PDU session does exist, then the UE 602 at step 708 can create a VPN tunnel for the already established PDU session and then can transmit data from the socket on a VPN for one of the plurality of VPNs mapped to the identified PDU session, wherein the VPN is established over the identified PDU session. The process can repeat itself for however many socket requests are received. For example, the UE 602 can receive another socket request from the client application (608), the other socket request indicating a different URSP traffic category. The UE 602 can then identify another PDU session associated with the different URSP traffic category indicated for in the other socket request such that another socket associated with the other socket request is bound to another identified PDU session. The UE 602 can then transmit data from the other socket on another VPN for one of the plurality of VPNs mapped to the other identified PDU session.

The VPN tunnel established can include a single tunnel to a VPN server in some embodiments, and in other embodiments, such as the private relay solution, a first tunnel (620) associated with the VPN is established between the UE (602) and a first VPN server (624) and then a second tunnel (622) associated with the VPN is established between the UE (602) and a second VPN server (626), wherein the second tunnel (622) is via the first VPN server (624).

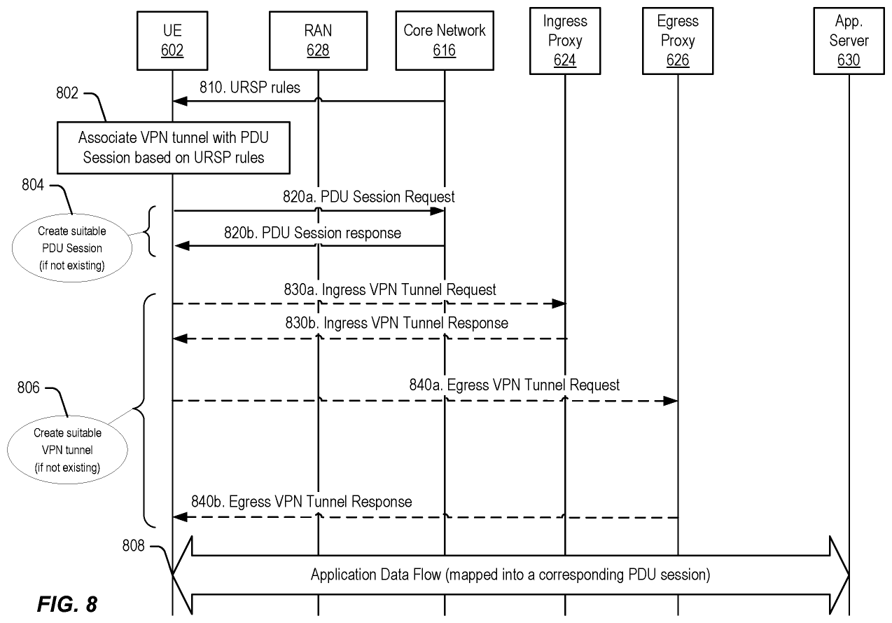

FIG. 8 illustrates a message sequence chart for employing multiple VPNs and URSP traffic categorization according to some embodiments of the present disclosure.

At 810, the UE 602 can receive the URSP rules from the core network 616 (and more specifically, in an embodiment, PCF 614).

At 802, the UE 602 can associate or map each VPN of the plurality of VPNs to a respective PDU session of a plurality of PDU sessions, wherein each PDU session is associated with a respective URSP traffic category corresponding to a respective QoS level. The mapping of each VPN of the plurality of VPNs to respective PDU sessions is based at least in part on the URSP rules. In an embodiment, or optionally, the mapping at 802 can be performed in response to or after a socket request is received from an application.

At 804, the UE 602 can create a suitable PDU session if a PDU session that is suitable for the socket request does not already exist. If the PDU session needs to be established, the UE 602 can send at 820a a PDU session request to the core network 616, and receive a response at 820b.

At 806, the UE 602 can create a suitable VPN if a VPN session that is suitable for the PDU session does not exist, and creating the VPN can comprise sending a first Ingress VPN tunnel request to the Ingress proxy 624 at step 830a, and receive an Ingress VPN tunnel Response server 620 at 830b.

At 840a, the UE 602 can send an Egress VPN Tunnel Request to the Egress Proxy 626 that includes the IP address of the Application server 620. The Egress Proxy 626 can then send to the UE 602 at 840b an Egress VPN tunnel Response that indicates an encrypted VPN tunnel has been established to the Egress Proxy 626.

Once both VPN tunnels are established, the Application Server 630 and the UE 602 can establish application data flow both direction at 808. The application data flow, and both VPN tunnels can be mapped into a corresponding PDU session.

It is to be appreciated that the message sequence chart in FIG. 8 is suitable for a private relay type solution. In other embodiments, a shortened message sequence chart can be used for a single VPN tunnel solution.

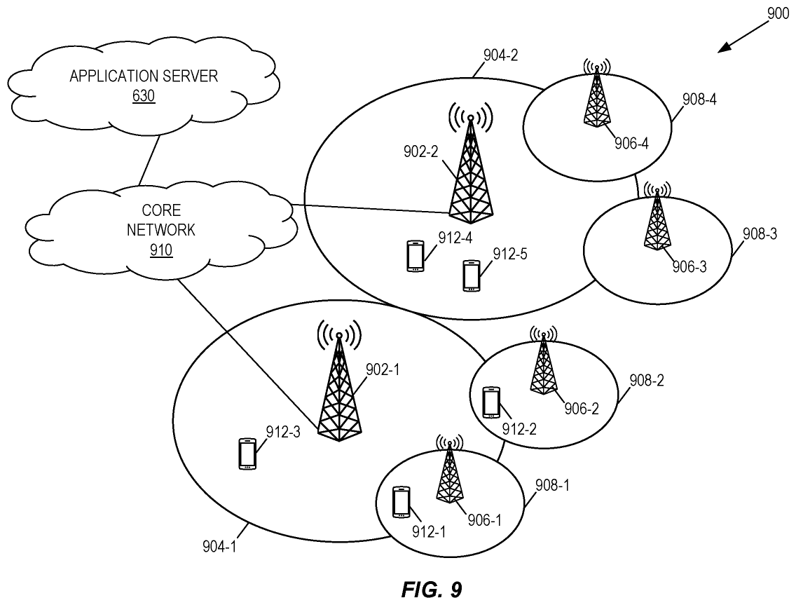

FIG. 9 illustrates one example of a cellular communications system 900 in which embodiments of the present disclosure may be implemented. In the embodiments described herein, the cellular communications system 900 can be a 5G system (5GS) including a Next Generation RAN (NG-RAN) and a 5G Core (5GC) or an Evolved Packet System (EPS) including an Evolved Universal Terrestrial RAN (E-UTRAN) and an Evolved Packet Core (EPC). In this example, the RAN includes base stations 902-1 and 902-2, which in the 5GS include NR base stations (gNBs) and optionally next generation eNBs (ng-eNBs) (e.g., LTE RAN nodes connected to the 5GC) and in the EPS include eNBs, controlling corresponding (macro) cells 904-1 and 904-2. The base stations 902-1 and 902-2 are generally referred to herein collectively as base stations 902 and individually as base station 902. Likewise, the (macro) cells 904-1 and 904-2 are generally referred to herein collectively as (macro) cells 904 and individually as (macro) cell 904. The RAN may also include a number of low power nodes 906-1 through 906-4 controlling corresponding small cells 908-1 through 908-4. The low power nodes 906-1 through 906-4 can be small base stations (such as pico or femto base stations) or Remote Radio Heads (RRHs), or the like. Notably, while not illustrated, one or more of the small cells 908-1 through 908-4 may alternatively be provided by the base stations 902. The low power nodes 906-1 through 906-4 are generally referred to herein collectively as low power nodes 906 and individually as low power node 906. Likewise, the small cells 908-1 through 908-4 are generally referred to herein collectively as small cells 908 and individually as small cell 908. The cellular communications system 900 also includes a core network 910, which in the 5GS is referred to as the 5GC. The base stations 902 (and optionally the low power nodes 906) are connected to the core network 910. The core network 910 can include a PCF 614 that can provide URSP rules to the UE 912 as described above with reference to FIG. 6.

The base stations 902 and the low power nodes 906 provide service to UEs 912-1 through 912-5 in the corresponding cells 904 and 908. The UEs 912-1 through 912-5 are generally referred to herein collectively as UEs 912 and individually as UE 912. In the following description, the UEs 912 are oftentimes UEs, but the present disclosure is not limited thereto. The UEs 912 can established VPNs to encrypt data sent between the UEs 912 and the application server 630 via the core network 910 and the RAN.

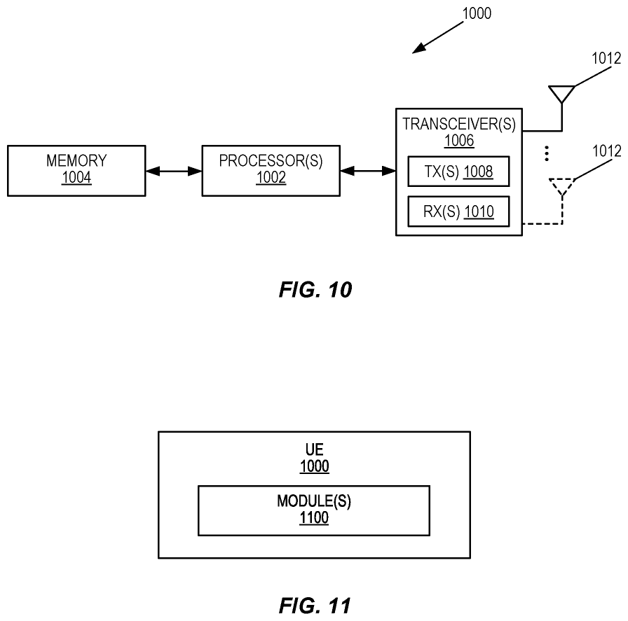

FIG. 10 is a schematic block diagram of a UE 1000 according to some embodiments of the present disclosure. As illustrated, the UE 1000 includes one or more processors 1002 (e.g., Central Processing Units (CPUs), Application Specific Integrated Circuit (ASICs), Field Programmable Gate Arrays (FPGAs), and/or the like), memory 1004, and one or more transceivers 1006 each including one or more transmitters 1008 and one or more receivers 1010 coupled to one or more antennas 1012. The transceiver(s) 1006 includes radio-front end circuitry connected to the antenna(s) 1012 that is configured to condition signals communicated between the antenna(s) 1012 and the processor(s) 1002, as will be appreciated by on of ordinary skill in the art. The processors 1002 are also referred to herein as processing circuitry. The transceivers 1006 are also referred to herein as radio circuitry. In some embodiments, the functionality of the UE 1000 described above may be fully or partially implemented in software that is, e.g., stored in the memory 1004 and executed by the processor(s) 1002. Note that the UE 1000 may include additional components not illustrated in FIG. 10 such as, e.g., one or more user interface components (e.g., an input/output interface including a display, buttons, a touch screen, a microphone, a speaker(s), and/or the like and/or any other components for allowing input of information into the UE 1000 and/or allowing output of information from the UE 1000), a power supply (e.g., a battery and associated power circuitry), etc.

In an embodiment, UE 1000 can be similar to and perform the functionality described with respect to UE 602 in FIGS. 6, 7, and 8.

In some embodiments, a computer program including instructions which, when executed by at least one processor, causes the at least one processor to carry out the functionality of the UE 1000 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 11 is a schematic block diagram of the UE 1000 according to some other embodiments of the present disclosure. The UE 1000 includes one or more modules 1100, each of which is implemented in software. The module(s) 1100 provide the functionality of the UE 1000 described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

At least some of the following abbreviations may be used in this disclosure. If there is an inconsistency between abbreviations, preference should be given to how it is used above. If listed multiple times below, the first listing should be preferred over any subsequent listing(s).
3GPP Third Generation Partnership Project
5G Fifth Generation
5GC Fifth Generation Core
5GS Fifth Generation System
5QI Fifth Generation Quality of Service Identifier
AF Application Function
AMF Access and Mobility Function
AN Access Network
ASIC Application Specific Integrated Circuit
AUSF Authentication Server Function
CN Core Network
CPU Central Processing Unit
CSP Communication Service Provider
DCI Downlink Control Information
DL Downlink
DN Data Network
DNN Data Network Name
DSP Digital Signal Processor
eNB Enhanced or Evolved Node B
EPC Evolved Packet Core
EPS Evolved Packet System
E-UTRA Evolved Universal Terrestrial Radio Access
FPGA Field Programmable Gate Array
gNB New Radio Base Station
gNB-DU New Radio Base Station Distributed Unit
HSS Home Subscriber Server
IP Internet Protocol
LTE Long Term Evolution
MME Mobility Management Entity
NEF Network Exposure Function
NF Network Function
NI-QoS Network Initiated-Quality of Service
NR New Radio
NRF Network Function Repository Function
NSSF Network Slice Selection Function
OS Operating System
PCF Policy Control Function
PDU Protocol Data Unit
P-GW Packet Data Network Gateway
QCI Quality of Service Class Identifier
QoE Quality of Experience
QoS Quality of Service
RAM Random Access Memory
RAN Radio Access Network
ROM Read Only Memory
RRH Remote Radio Head
SCEF Service Capability Exposure Function
SLA Service Level Agreement
SMF Session Management Function
UDM Unified Data Management
UE User Equipment
UL Uplink
UPF User Plane Function
URSP User Equipment Route Selection Policy
VPN Virtual Private Network
WAN Wide Area Network

Those skilled in the art will recognize improvements and modifications to the embodiments of the present disclosure. All such improvements and modifications are considered within the scope of the concepts disclosed herein.

1. A method performed by a User Equipment (UE) for enabling use of one or more Virtual Private Network (VPN) tunnels with UE Route Selection Policy (URSP) traffic classification, the method comprising:
mapping each VPN tunnel to a respective Protocol Data Unit (PDU) session of one or more PDU sessions, wherein each PDU session is associated with a respective URSP traffic category corresponding to a respective Quality of Service (QoS) level;
receiving a network connection setup request from a client application of the UE, the network connection setup request indicating a URSP traffic category;
identifying a PDU session that is associated with a URSP traffic category based on the URSP traffic category indicated in the network connection setup request such that a network connection associated with the network connection setup request is bound to the identified PDU session; and
transmitting data from the client application via the network connection to a VPN tunnel mapped to the identified PDU session, wherein the VPN tunnel is established over the identified PDU session.

2. The method of claim 1, further comprising:
establishing the VPN tunnel that corresponds to the PDU session, wherein the VPN tunnel utilizes the PDU session as a network resource.

3. The method of claim 1, further comprising:
determining that the identified PDU session associated to the indicated URSP traffic category is not established; and
establishing the identified PDU Session.

4. The method of claim 1, further comprising:
receiving URSP rules from a core network node, wherein the mapping each VPN tunnel of the one or more of VPN tunnels to respective PDU sessions is based at least in part on the URSP rules.

5. The method of claim 4, wherein a URSP rule of the URSP rules points to a Data Network Name (DNN) selection field, in the Route Selection component that indicates a PDU session for a corresponding URSP traffic category.

6.-7. (canceled)

8. The method of claim 1, further comprising:
receiving another network connection setup request from the client application, the other network connection setup request indicating a different URSP traffic category;
identifying another PDU session associated with the different URSP traffic category indicated for in the other network connection setup request such that another network connection associated with the other network connection setup request is bound to another identified PDU session; and
transmitting data from the client application via the other network connection to the other VPN tunnel mapped to the other identified PDU session.

9.-10. (canceled)

11. The method of claim 1, wherein the URSP traffic category is at least one of a plurality of URSP traffic categories comprising:
a low latency traffic category;
a background traffic category;
a default traffic category;
a high bandwidth traffic category;
a medium bandwidth traffic category;
a bounded medium latency traffic category; or
a time-critical traffic category.

12. A User Equipment (UE) configured for enabling use of one or more Virtual Private Network (VPN) tunnels with UE Route Selection Policy (URSP) traffic classification, the UE comprising a radio interface and processing circuitry configured to:
map each VPN tunnel to a respective Protocol Data Unit (PDU) session of one or more PDU sessions, wherein each PDU session is associated with a respective URSP traffic category corresponding to a respective Quality of Service (QoS) level;
receive a network connection setup request from a client application of the UE, the network connection setup request indicating a URSP traffic category;
identify a PDU session that is associated with a URSP traffic category based on the URSP traffic category indicated in the network connection setup request such that a network connection associated with the network connection setup request is bound to the identified PDU session; and
transmit data from the client application via the network connection to a VPN tunnel mapped to the identified PDU session, wherein the VPN tunnel is established over the identified PDU session.

13. The UE of claim 11, wherein the processing circuitry is further configured to:
establish the VPN tunnel that corresponds to the PDU session, wherein the VPN tunnel utilizes the PDU session as a network resource.

14. The UE of claim 12, wherein the processing circuitry is further configured to:
determine that the identified PDU session associated to the indicated URSP traffic category is not established; and
establish the identified PDU Session.

15. The UE of claim 12, wherein the processing circuitry is further configured to:
receive URSP rules from a core network node, wherein the mapping each VPN tunnel of the one or more of VPN tunnels to respective PDU sessions is based at least in part on the URSP rules.

16. The UE of claim 15, wherein a URSP rule of the URSP rules points to a Data Network Name (DNN) selection field, in the Route Selection component that indicates a PDU session for a corresponding URSP traffic category.

17.-18. (canceled)

19. The UE of claim 12, wherein the processing circuitry is further configured to:
receive another network connection setup request from the client application, the other network connection setup request indicating a different URSP traffic category;
identify another PDU session associated with the different URSP traffic category indicated for in the other network connection setup request such that another network connection associated with the other network connection setup request is bound to another identified PDU session; and
transmit data from the client application via the other network connection to the other VPN tunnel mapped to the other identified PDU session.

20.-21. (canceled)

22. The UE of claim 12, wherein the URSP traffic category is at least one of a plurality of URSP traffic categories comprising:
a low latency traffic category;
a background traffic category;
a default traffic category;
a high bandwidth traffic category;
a medium bandwidth traffic category;
a bounded medium latency traffic category; or
a time-critical traffic category.

23. A non-transitory computer-readable medium comprising instructions stored thereon, that when implemented by a processor perform operations for enabling use of one or more Virtual Private Network (VPN) tunnels with a User Equipment Route Selection Policy (URSP) traffic classification, the operations comprising:
mapping each VPN tunnel to a respective Protocol Data Unit (PDU) session of one or more PDU sessions, wherein each PDU session is associated with a respective URSP traffic category corresponding to a respective Quality of Service (QoS) level;
receiving a network connection setup request from a client application of a User Equipment (UE) the network connection setup request indicating a URSP traffic category;
identifying a PDU session that is associated with a URSP traffic category based on the URSP traffic category indicated in the network connection setup request such that a network connection associated with the network connection setup request is bound to the identified PDU session; and
transmitting data from the client application via the network connection to a VPN tunnel mapped to the identified PDU session, wherein the VPN tunnel is established over the identified PDU session.
